(19) United States
(12) Patent Application Publication
(10) Pub. No.: US 2019/0037878 A1
(43) Pub. Date: Feb. 7, 2019

(54) RECEPTACLE AND VALVE ASSEMBLY

(71) Applicant: Conopco, Inc., d/b/a UNILEVER, Englewood Cliffs, NJ (US)

(72) Inventors: Alberto GARCIA NARANJO, Ipswich (GB); Paul SCOTT, Histon (GB)

(21) Appl. No.: 16/067,829

(22) PCT Filed: Dec. 9, 2016
(86) PCT No.: PCT/EP2016/080425

§ 371 Date: Jul. 3, 2018

(30) Foreign Application Priority Data
Jan. 8, 2016 (EP) 16150663.9

(51) Int. Cl. A23G 9/08; A23G 9/22; A23G 9/28; A23G 9/30

(52) U.S. Cl. CPC A23G 9/086; A23G 9/222; A23G 9/281; A23G 9/30; A23G 9/287

(57) ABSTRACT

Disclosed is a receptacle and valve assembly (100) for use in a device (1) for dispensing frozen confection (13). The receptacle (8) comprises a product compartment (20) containing the frozen confection located inside a bottle and having a tubular outlet (22). The valve (7) comprises a tubular inlet (41) having a deformable gasket (43) on an outer surface thereof. The tubular inlet (41) of the valve is receivable within the tubular outlet (22) of the receptacle to allow the deformable gasket (43) to form a fluid-tight seal with an inner wall of the tubular outlet.

### FIELD OF THE INVENTION

The present invention relates to dispensing frozen confections. In particular, the invention relates to dispensing frozen confections from receptacles fitted with valves.

### BACKGROUND OF THE INVENTION

In recent years, systems for dispensing frozen confections such as soft ice cream have been developed in which pre-packaged ice cream is delivered from a container by a dispensing device. In particular systems which employ bag-in-bottle type containers have been developed.

WO 2013/124193 A discloses a method for dispensing a frozen confection comprising: providing a refrigerated, insulated chamber, which houses at least one container, containing a frozen confection at a temperature of −12 ° C. or below; wherein the at least one container has an outlet which is closed by a self-closing valve; wherein the container comprises a flexible bag containing the frozen confection located inside a bottle; pressurising gas in the region inside the bottle and outside the flexible bag thereby applying pressure to the frozen confection so that the valve opens and the frozen confection is forced out of the container through the outlet; releasing the pressure so that the valve closes.

Such systems have recently been made commercially available under the My Cornetto® brand for use in out-of-home retail establishments. The container and self-closing valve in such systems are typically supplied to a retailer already assembled, with each container having its own valve. This is convenient for the retailer and the provision of each container with its own valve is affordable owing to the relatively large volume of ice held by each container.

The present inventors have now recognized that there is a need for improvements in systems for dispensing food compositions like soft ice. In particular the present inventors have found that there is a need for receptacle-valve assemblies whereby the container and valve can be readily assembled and/or separated, allowing reuse of the valve. These advantages are especially apparent where the system is for domestic in-home use.

### SUMMARY OF THE INVENTION

In a first aspect, the present invention is directed to a receptacle and valve assembly for use in a device for dispensing a frozen confection, wherein:
the receptacle comprises a product compartment containing the frozen confection located inside a bottle and having a tubular outlet; and
the valve comprises a tubular inlet having a deformable gasket on an outer surface thereof;
   wherein the tubular inlet of the valve is receivable within the tubular outlet of the receptacle to allow the deformable gasket to form a fluid-tight seal with an inner wall of the tubular outlet.

The use of such an assembly where the valve can be readily received by the receptacle allows for reusable valves to be employed. Furthermore an advantage of having the tubular inlet of the valve receivable within the tubular outlet of the receptacle is that the valve can be removed from the receptacle without leaving residual frozen confection on an outer surface of the receptacle. Such residual surface frozen confection is unhygienic. In addition, in the case where the receptacle is not empty and will be reused at a future time, frozen surface residue may interfere with sealing of the valve and receptacle if the tubular outlet of the receptacle were receivable in the tubular outlet of the valve.

Preferably the deformable gasket comprises one or more o-rings. Additionally or alternatively the gasket may be formed from rubber or another elastomeric material.

As the valve may be reused, it can be engineered to precisely control dispensing of the frozen confection without the need to use a variable dispensing force. Preferably the valve comprises a dispensing outlet closed by a retractable stem as such an arrangement has the advantage that the dispensing force acting on the frozen confection does not have to be removed between each serving as the stem can be used to simply block the dispensing path of the frozen confection. Where gas pressure is used to generate the dispensing force, this allows for use of smaller pumps and/or dispenses with the need for a gas reservoir. Preferably the stem is retractable against the force of a resiliently biasable member (such as a spring) which acts to push the stem back into a closed position on removal of an opening force. Additionally or alternatively the stem is retractable in a vertical direction and the tubular inlet extends radially outwards. Most preferably the radially extending tubular inlet is receivable in a radially extending tubular outlet of the receptacle. This arrangement allows for improved hygienic removal of the valve from the receptacle as neither the inlet nor the outlet faces downwards during removal and so product in the valve/receptacle is less likely to fall out under gravity.

The present invention is applicable to a range of frozen confections. Frozen confection means a confection made by freezing a mix (preferably a pasteurized mix) of ingredients such as water, fat, sweetener, protein (normally milk proteins), and optionally other ingredients such as emulsifiers, stabilisers, colours and flavours. Frozen confection materials may be aerated. Frozen confection materials include ice cream, gelato, frozen yoghurt, sorbets, granitas, shaved ices and the like. Preferably the frozen confection is ice cream.

The frozen confection may be aerated. The term “aerated” means that gas has been intentionally incorporated into the product, such as by mechanical means. The gas can be any food-grade gas such as air, nitrogen or carbon dioxide. The extent of aeration is typically defined in terms of “overrun” (OR). In the context of the present invention, % overrun is defined in volume terms (measured at atmospheric pressure) as:

$$O R = \frac{\begin{matrix}volume of frozen aerated product - \\ volume of premix at ambient temp\end{matrix}}{volume of premix at ambient temp} \times 100$$

The amount of overrun present in the aerated frozen confection will vary depending on the desired product characteristics. In the context of the present invention the level of overrun is typically from 0 to 150%, more preferably from 60 to 150%, most preferably from 60 to 100%.

The dispensing of food compositions is most effectively and hygienically achieved if the dispensing force does not act directly on the food composition but rather through a moveable wall (such as piston, bag or membrane). Thus, it is preferred that the receptacle comprises a moveable wall through which a dispensing force can be transmitted to the frozen composition. Examples of such receptacles include bag-in-bottles (where the bag acts as the moveable wall) and cartridges containing pistons (where the piston acts as the moveable wall) although other configurations are possible including, for example, containers with an end wall that is deformable to become the moveable wall (as described, for example in U.S. Pat. No. 5,893,485). Examples of bag-in-bottle type receptacles are described in WO 2007/039158 A and examples of piston-in-cartridge type receptacles are described in EP 1 449 441 A both of which documents are hereby incorporated by reference in their entirety.

A convenient means of applying a dispensing force is through compressed gas pressure.

Therefore it is preferred that the receptacle comprises a compressed gas inlet. More preferably the receptacle comprises a propellant compartment separated from the product compartment by the moveable wall, wherein the propellant compartment is in fluid communication with the compressed gas inlet.

The utility of the present invention is especially enhanced where the receptacle is replaceable in the device. Therefore it is preferred that the receptacle is disposable or recyclable.

The receptacle preferably contains multiple portions of frozen confection, more preferably wherein the receptacle contains at least 200 g of frozen confection, even more preferably between 250 and 3000 g, more preferably still between 300 and 2000 g and most preferably between 400 and 1000 g.

Preferably the bottle comprises one or more shoulders adjoining the tubular outlet as such shoulders can provide convenient locations for restraining the receptacle against movement when a dispensing for is applied.

As the valve of the present invention is preferably easily inserted and removed from the receptacle, it is preferable that the device for dispensing the frozen confection has means to prevent the valve being blown out of the receptacle when the dispensing force is applied.

Thus, in a second aspect the present invention provides a device for dispensing frozen confection from the receptacle and valve assembly of any embodiment of the first aspect wherein the device comprises:
a system for applying a dispensing force to the product compartment; and
a valve restraint for bracing the valve against the dispensing force.

Preferably the valve restraint comprises one or more blocks made from metal, more preferably aluminium, steel or a combination thereof.

If the receptacle comprises a compressed gas inlet, the system for applying a dispensing force preferably comprises:
a compressed gas source; and
a gas conduit extending from the compressed gas source to a compressed gas outlet connectable to the compressed gas inlet of the receptacle.

The device preferably comprises an actuation mechanism for actuating the valve. As the actuation mechanism necessarily needs to contact the valve, at least to apply an opening force thereto, it is preferred that the valve restraint forms part of the actuation mechanism.

Where the bottle comprises one or more shoulders adjoining the tubular outlet, the device preferably comprises a shoulder restraint for bracing the shoulder(s) of the bottle against the dispensing force.

Preferably the shoulder restraint comprises one or more blocks made from metal, more preferably aluminium, steel or a combination thereof.

Preferably the shoulder restraint comprises a recess for receiving the tubular outlet of the receptacle.

In a third aspect the present invention is directed to a method for dispensing frozen confection comprising:
assembling the valve and receptacle into an assembly according to any embodiment of the first aspect;
applying a dispensing force to the product compartment; and
opening the valve to allow the dispensing force to urge at least some of the frozen confection out of the valve.

After dispensing at least a portion of the frozen confection, the valve is typically removed from the receptacle. Therefore, preferably the method comprises the additional steps of:
closing the valve;
removing the dispensing force; and
disassembling the assembly by removing the tubular inlet of the valve from the tubular outlet of the receptacle.

In a preferred embodiment the valve is then cleaned so it can be reused with the same receptacle or a new receptacle.

Were the receptacle contains multiple portions of frozen confection, the receptacle will typically be stored in a freezer between dispensing occasions as this removes or at least reduces the need for the device to have its own refrigeration means and/or to be insulated. Thus in a preferred embodiment of the method, the receptacle is stored at a temperature of less than −7° C., more preferably less than −12° C., most preferably at a temperature of from −15 to −25° C. after being disassembled from the valve. For example, the receptacle is stored in a freezer, preferably a domestic freezer. For hygienic reasons, it is preferred that the tubular outlet of the receptacle is capped during storage.

### DETAILED DESCRIPTION OF PREFERRED EMBODIMENTS

The present invention will now be described, by way of example only, with reference to the figures, wherein:

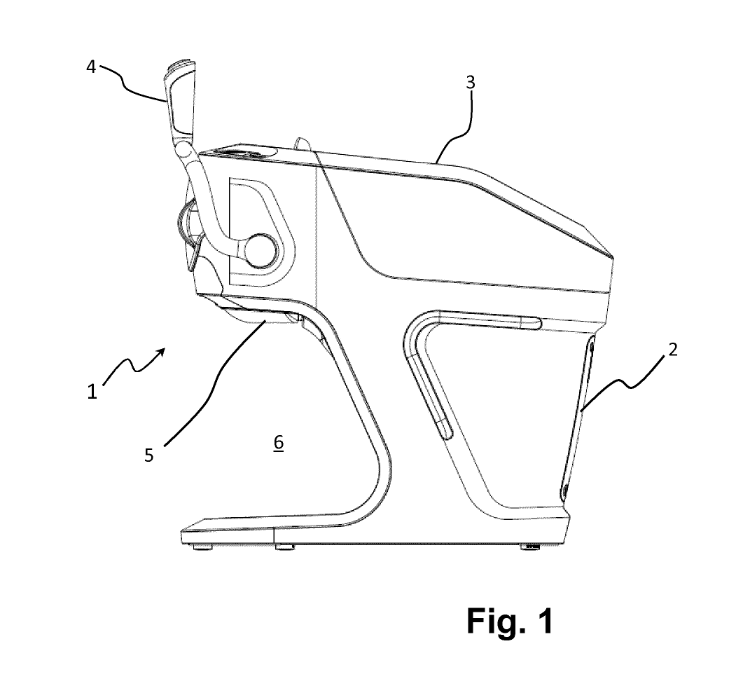

FIG. 1 shows a side view of the outside of a device according to an embodiment of the invention and which dispenses frozen confection from bag-in-bottle type receptacles.

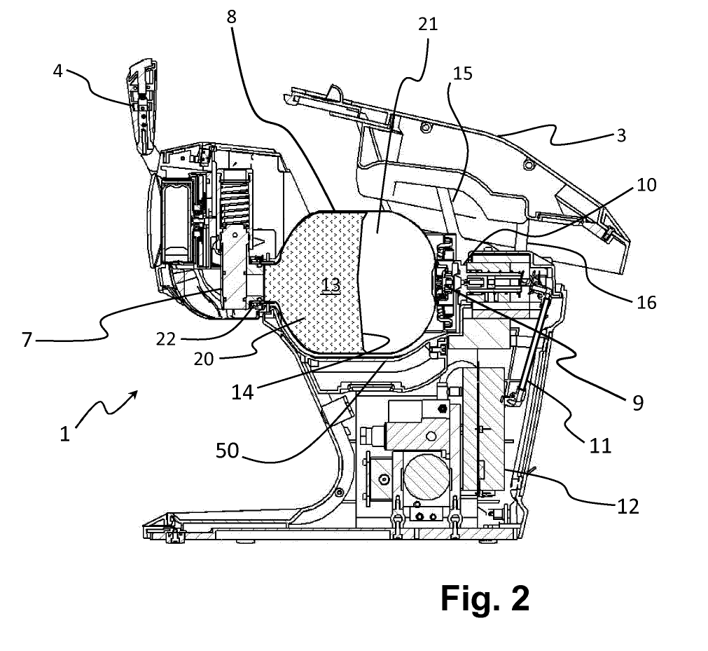

FIG. 2 shows a sectional view of the device of FIG. 1 with its door open and a receptacle and valve assembly in place for dispensing.

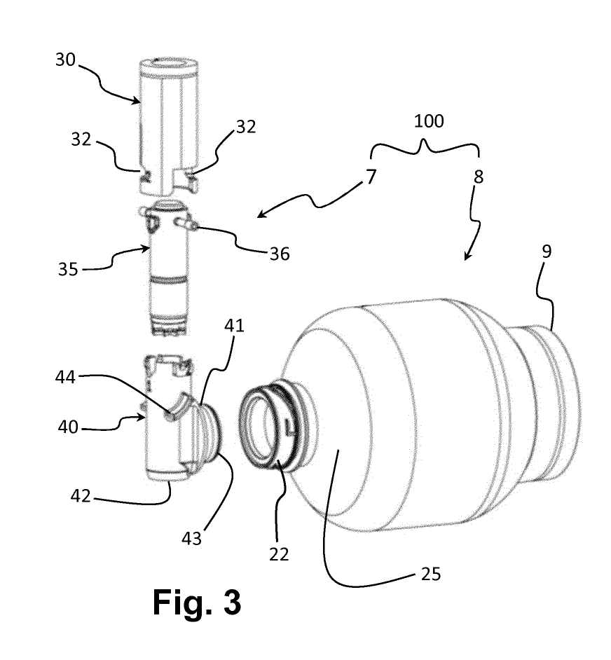

FIG. 3 shows an exploded view of the receptacle and valve assembly for use in the device of FIG. 1.

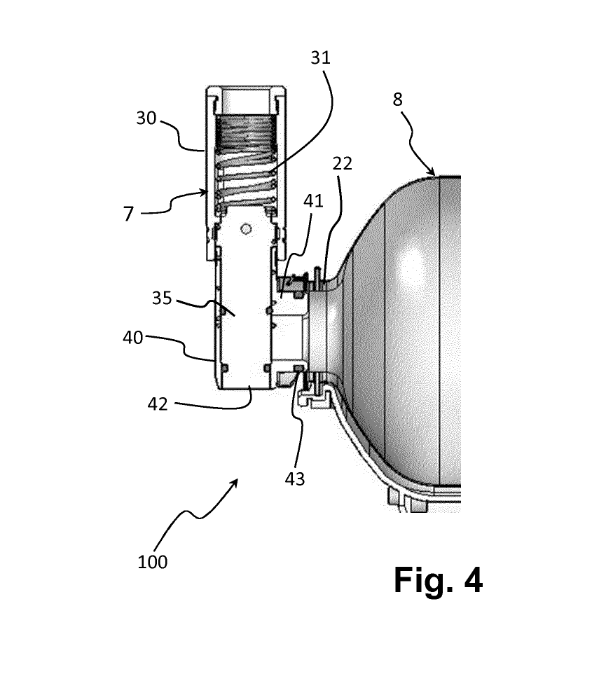

FIG. 4 shows a sectional view of the valve and part of the receptacle of the assembly of FIG. 3 after being assembled.

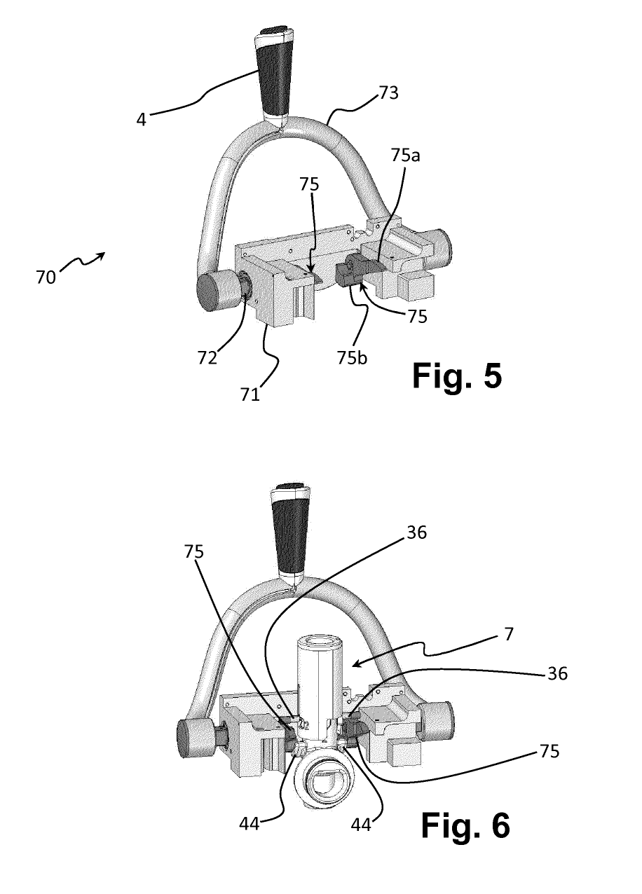

FIG. 5 show a back perspective view of the valve actuation mechanism for use in the device of FIG. 1.

FIG. 6 shows the valve actuation mechanism of FIG. 5 with the valve in place.

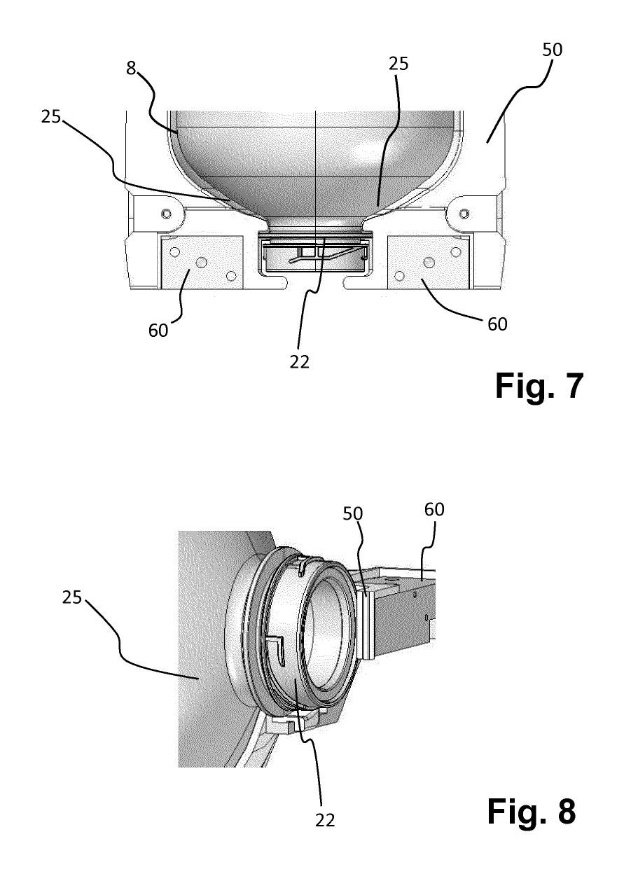

FIG. 7 shows a top view of the shoulder restraint of the device of FIG. 1 with a receptacle in place (the valve has been omitted for clarity).

FIG. 8 shows a sectional perspective view of the shoulder restraint of FIG. 7.

The embodiment of the device shown in FIGS. 1 to 8 is suitable for dispensing frozen confections from bag-in-bottle type receptacles. The device (1) comprises a housing (2) and an upper door (3) which together enclose the receptacle (8) and valve (7). The door (3) is connected to the housing (2) through two pairs of leg struts (15,16) to provide a 4 bar linkage mechanism about which the door can be moved in and out of closure with the housing (2).

The bag (14) inside the bottle of the receptacle (8) forms a compartment (20) containing the frozen confection (13). The compartment (20) containing the frozen confection (13) is open at a tubular outlet (22) which is also the neck of the bottle of the receptacle (8) and which receives the tubular inlet (41) of the valve (7). The bottle of the receptacle (8) also comprises an inlet (9) through which compressed gas can be introduced through an orifice thereof to a propellant compartment (21) separated from the product compartment (20) by the bag (14).

As best seen in FIG. 2, the device (1) comprises a gas outlet (10) which with the door (3) in an open position is aligned with but spaced away from the gas inlet (9) of the receptacle (8). The gas outlet (10) is connected to an air pump (12) through an air line (11), forming in this embodiment the compressed gas source and conduit respectively.

The receptacle and valve assembly (100) is shown in detail in FIGS. 3 and 4.

The valve (7) can be separated into three parts for easy cleaning: a cap (30), a valve stem (35) and a valve housing (40). The cap contains a spring (31) and has two recesses (32) for receiving actuating rods (36) which project from the surface of the stem (35). The recesses (32) are L-shaped such that the stem (35) can be locked in the cap (30) by inserting the actuating rods (36) in the bottom of the recesses (32) and then twisting the cap (30) in a clockwise direction. The stem (35) complete with cap (30) can then be slid into the bore of the housing (40) where it is sealed therein owing to o-rings located on the stem (35).

The valve housing (40) comprises a main cylindrical section which contains a bore and which has on its outer surface a pair of retaining ribs (44). The bore is for receiving the stem (35). Radially projecting from the main cylindrical section of the housing (40) is a tubular inlet (41). The tubular inlet (41) has a gasket (43) in the form of an elastomeric o-ring on its outside surface. With the valve (7) assembled, the stem (35) is held in a sealing position in the housing (40) owing to downward force of the spring (31), wherein the o-rings located on the stem (35) prevent fluid communication between the tubular inlet (41) and a dispensing orifice (42) of the housing (40). On assembling the valve the retaining ribs (45) each locate below one of the recesses (32) in which is received an actuating rod (36).

The valve-receptacle assembly (100) is assembled by pushing the tubular inlet (41) of the valve (7) into the tubular outlet (22) of the receptacle (8), wherein the o-ring (43) is compressed against the inner surface of the tubular outlet (22) to provide a fluid-tight fit.

The bottle of the receptacle (8) comprises a generally cylindrical body that has a much greater diameter than the tubular outlet (22) and so the receptacle body narrows as it meets the tubular outlet (22) to form a shoulder (25).

FIGS. 5 and 6 shows the actuation mechanism (70) which forms part of the device (1) and is used to apply an opening force to the valve (7) when located therein. The mechanism (70) comprises a handle (4) which is disposed centrally on a handle bar (73). Each end of the handle bar (73) is connected to a transmission spindle (72) which passes through a bearing block (71) to an actuating head (75). Each actuating head (75) has an upper curved cam surface (75a) and a lower curved cam surface (75b).

When located in the device (1) the valve (7) sits between the two actuating heads (75) with each retaining rib (44) sitting under the corresponding actuating head (75) as shown in FIG. 6. In the event that the valve (7) experiences a force urging it forward upon application of the gas pressure to the receptacle, the abutment of the retaining ribs (44) with the actuating heads (75) prevents the valve (7) from being pushed out of engagement with the receptacle (8). The connection of the actuating heads (75) with the bearing block (71) helps absorb some of the stress caused by the dispensing force urging the valve (7) forward. Thus the actuating heads (75) and bearing block (71) form the valve restraint of this embodiment. In this respect it is preferable that the bearing block (71) is formed from a metal such as aluminium. The actuating heads (75) are also preferably formed from metal.

To open the valve, a user pulls the handle (4) downwards which moves the handle bar (73) along an arcuate path about an axis (“transmission axis”) passing through the transmission spindles (75). The motion of the handle bar (73) rotates each spindle (75) which in turn causes the actuating heads (75) to rotate in a counter-clockwise direction about the transmission axis. As each head (75) rotates, its lower cam surface (75b) moves along the upper surface of the corresponding retaining rib (44) of the valve (7) and its upper cam surface (75a) pushes the corresponding actuating rod (36) upwards.

Thus the lower cam surface (75b) keeps the housing (40) stationary whilst the upper cam surface (75a) lifts the stem (35) upwards to open a flow path between the tubular inlet (41) and the dispensing orifice (42).

FIGS. 7 and 8 show that the device (1) comprises a shoulder restraint to retain the receptacle (8) in place when the gas pressure is applied. The restraint comprises a solid metal block (60) that is shaped to retain the shoulder (25) of the receptacle (8) whilst having a recess to receive the tubular outlet (22). In the embodiment shown the device (1) additionally comprises a seat (50) made from plastic material and in the region of the shoulder restraint forms a cushion between the metal block (60) and the receptacle (8).

In use, the valve (7) is first assembled as described above. A receptacle (8) filled with ice cream or another frozen confection (13) is then taken from a storage freezer and the tubular inlet (41) of the valve (7) inserted in the tubular outlet (22) of the receptacle to form the receptacle-valve assembly (100). The assembly (100) is then installed in the device (1) as shown in FIG. 2. The door (3) is then swung closed about the 4 bar linkage formed by the struts (15, 16). As the rear struts (16) pivot forward, they move the gas outlet (10) into sealing engagement with the gas inlet (9) of the receptacle (8) through a transmission mechanism (not shown).

The housing (2) also comprises a micro-switch (not shown) which is activated only when the door (3) is in the closed position. Activation of the micro-switch causes the air pump to be activated and begin feeding air through the air line (11), the gas outlet (10) and the gas inlet (9) into the propellant compartment (21) of the receptacle (8). Air is pumped until the desired pressure (for example about 2 bar) is achieved.

The user then actuates the valve (7) by pulling a handle (4). Downwards movement of the handle causes the actuation mechanism (70) to push the actuating rods upwards which in turn lifts the valve stem (35) from its sealing position as described above. The frozen confection (13) is urged through the open valve (7) by the air pressure acting on the bag (14). The dispensed ice cream flows through the dispensing orifice (42) to a dispensing opening (5) below the valve (7) and above a space (6) which can accommodate a bowl, cone or other receptacle. If a large amount of ice cream is dispensed then the air pump (12) may periodically activate to keep the pressure within the receptacle (8) above a set threshold and thus prevent the flow rate of the ice cream becoming too slow.

Once the desired amount of ice cream has been dispensed, the user returns the handle (4) to its original position which in turn causes the stem (35) to be pushed downward to close the valve under the force of the spring (31). The user then opens the door (3) which causes the pump to deactivate and pressure inside the device and receptacle to be dumped. As the door (3) is opened, the rear struts (16) pivot backwards, causing the gas outlet (10) to slide away from the gas inlet (9) of the receptacle (8).

The user then removes the receptacle-valve assembly (100) from the device (1). The tubular inlet (41) of the valve (7) is then pulled from the tubular outlet (22) of the receptacle (8) to separate the valve (7) and receptacle (8). A cap (not shown) is placed on the tubular outlet (22) of the receptacle (8) and the receptacle then placed in the storage freezer until the next dispensing occasion or (if empty) sent for recycling. Meanwhile the valve (7) can be cleaned by flushing with water and (optionally) detergent. Conveniently the valve (7) is separated into the three parts (cap (30), stem (35) and valve housing (40)) to allow more efficient and complete cleaning.

Because during dispensing the frozen confection (13) flows out of the receptacle (8) through the tubular inlet (41) of the valve inserted in the tubular outlet (22) of the receptacle (8), the outer surface of the receptacle (8) never comes into contact with frozen confection (13). Thus there is no need to clean the receptacle (8) after a dispensing occasion. Furthermore the inner surface of the tubular outlet (22) stays substantially free from contact with frozen confection (13) and so allows for efficient sealing with the gasket (43) on the tubular inlet (41) of the valve.

All numbers in this description indicating amounts of material, time periods, length scales, conditions of reaction, physical properties of materials and/or use may optionally be understood as modified by the word “about”.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a method of the invention), such disclosure is also to be considered to apply to any other aspect of the invention (for example a device of the invention) mutatis mutandis.

1. A receptacle and valve assembly for use in a device for dispensing frozen confection, wherein:
the receptacle comprises a product compartment containing the frozen confection located inside a bottle and having a tubular outlet; and
the valve comprises a tubular inlet having a deformable gasket on an outer surface thereof;
wherein the tubular inlet of the valve is receivable within the tubular outlet of the receptacle to allow the deformable gasket to form a fluid-tight seal with an inner wall of the tubular outlet.

2. The assembly as claimed in claim 1 wherein the deformable gasket comprises one or more o-rings.

3. The assembly as claimed in claim 1 or claim 2 wherein the valve comprises a dispensing outlet closed by a retractable stem.

4. The assembly as claimed in any one of the preceding claims wherein the receptacle comprises a moveable wall through which a dispensing force can be transmitted to the frozen confection.

5. The assembly as claimed in claim 4 wherein the receptacle is a bag-in-bottle.

6. The assembly as claimed in any one of claim 4 or 5 wherein the receptacle comprises a compressed gas inlet.

7. The assembly as claimed in any one of the preceding claims wherein the receptacle contains multiple portions of frozen confection, preferably wherein the receptacle contains at least 200 g of frozen confection.

8. The assembly as claimed in any one of the preceding claims wherein the bottle comprises one or more shoulders adjoining the tubular outlet.

9. A device for dispensing frozen confection from the receptacle and valve assembly as claimed in any one of the preceding claims wherein the device comprises:
a system for applying a dispensing force to the product compartment; and
a valve restraint for bracing the valve against the dispensing force, preferably wherein the valve restraint comprises one or more metal blocks.

10. The device as claimed in claim 9 wherein the receptacle comprises a compressed gas inlet and the system for applying a dispensing force comprises:
a compressed gas source; and
a gas conduit extending from the compressed gas source to a compressed gas outlet connectable to the compressed gas inlet of the receptacle.

11. The device as claimed in claim 9 or claim 10 wherein the device comprises an actuation mechanism for actuating the valve and the valve restraint forms part of the actuation mechanism.

12. A method for dispensing frozen confection comprising:
providing a valve comprising a tubular inlet having a deformable gasket on an outer surface thereof;
providing a receptacle comprising a product compartment containing the frozen confection located inside a bottle and having a tubular outlet;
assembling the valve and receptacle into an assembly by inserting the tubular inlet of the valve into the tubular outlet of the receptacle to allow the deformable gasket to form a fluid-tight seal with an inner wall of the tubular outlet;
applying a dispensing force to the product compartment; and
opening the valve to allow the dispensing force to urge at least some of the frozen confection out of the valve.

13. The method as claimed in claim 12 wherein the method comprises the additional steps of:
closing the valve;
removing the dispensing force; and
disassembling the assembly by removing the tubular inlet of the valve from the tubular outlet of the receptacle.

14. The method as claimed in claim 13 wherein the method comprises the additional step of cleaning the valve.

15. The method as claimed in claim 13 or claim 14 the method comprises the additional step of storing the receptacle at a temperature of less than −7° C. after being disassembled from the valve.
